(19) United States
(12) Patent Application Publication
(10) Pub. No.: US 2021/0289796 A1
(43) Pub. Date: Sep. 23, 2021

(54) Sausage Bun Assembly

(71) Applicant: Roy Umbreit, Pt Sanilac, MI (US)

(72) Inventor: Roy Umbreit, Pt Sanilac, MI (US)

(21) Appl. No.: 16/823,893

(22) Filed: Mar. 19, 2020

(51) Int. Cl. A21D 13/33; A21D 13/40

(52) U.S. Cl. CPC A21D 13/33; A23L 13/65; A21D 13/40

(57) ABSTRACT

A sausage bun assembly includes a hot dog bun that has a hot dog depression therein. The hot dog depressions containing a hotdog and fluid condiments can be positioned in the hot dog depression to inhibit the fluid condiments and the hot dog from spilling from the hot dog bun. A bratwurst bun is includes that has a bratwurst depression therein for containing a bratwurst and fluid condiments within the bratwurst bun. The bratwurst depression inhibits the fluid condiments and the bratwurst from spilling from the bratwurst bun. A foot long sausage bun is included that has a foot long sausage depression therein for containing a foot long sausage and fluid condiments within the foot long sausage bun. The foot long sausage depression is closed at each end to inhibit the fluid condiments and the foot long sausage from spilling from the foot long sausage bun.

### CROSS-REFERENCE TO RELATED APPLICATIONS

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bun devices and more particularly pertains to a new bun device for containing a sausage and desired fluid condiments without spilling.

### (2) Description of Related Art Including Information Disclosed Under 37 CFR 1.97 and 1.98

The prior art relates to bun devices.

### BRIEF SUMMARY OF THE INVENTION

An embodiment of the disclosure meets the needs presented above by generally comprising a hot dog bun that has a hot dog depression therein. The hot dog depressions containing a hotdog and fluid condiments can be positioned in the hot dog depression to inhibit the fluid condiments and the hot dog from spilling from the hot dog bun. A bratwurst bun is includes that has a bratwurst depression therein for containing a bratwurst and fluid condiments within the bratwurst bun. The bratwurst depression inhibits the fluid condiments and the bratwurst from spilling from the bratwurst bun. A foot long sausage bun is included that has a foot long sausage depression therein for containing a foot long sausage and fluid condiments within the foot long sausage bun. The foot long sausage depression is closed at each end to inhibit the fluid condiments and the foot long sausage from spilling from the foot long sausage bun.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a sausage bun assembly according to an embodiment of the disclosure.

FIG. 2 is a top view of an embodiment of the disclosure.

FIG. 3 is a front view of an embodiment of the disclosure.

FIG. 4 is a bottom view of a hot dog bun of an embodiment of the disclosure.

FIG. 5 is a cross sectional view taken along line 5-5 of FIG. 4 of an embodiment of the disclosure.

### DETAILED DESCRIPTION OF THE INVENTION

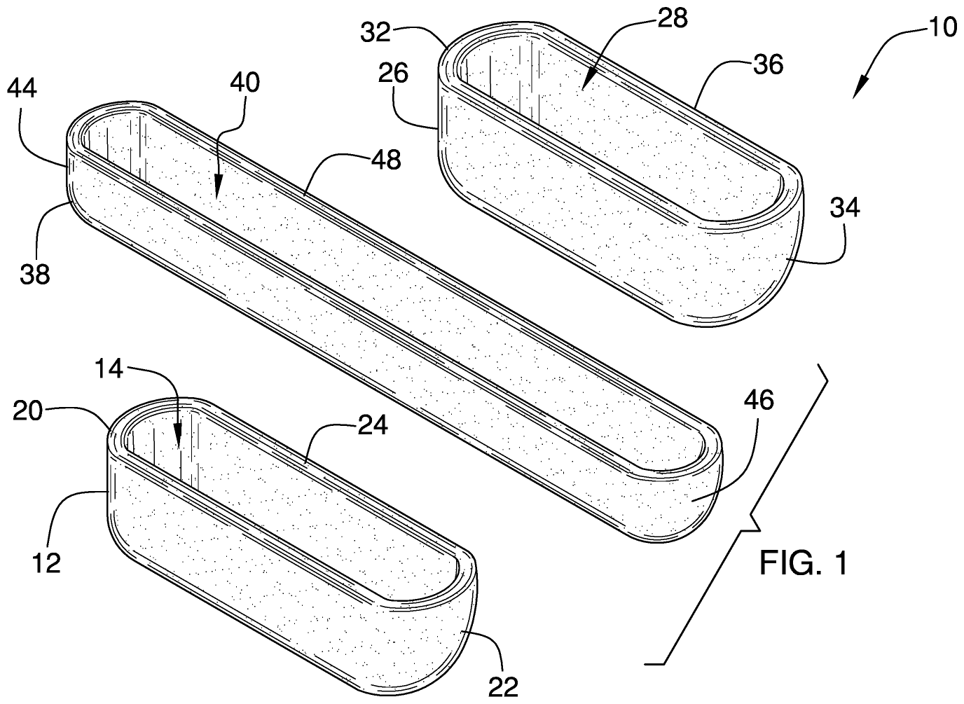

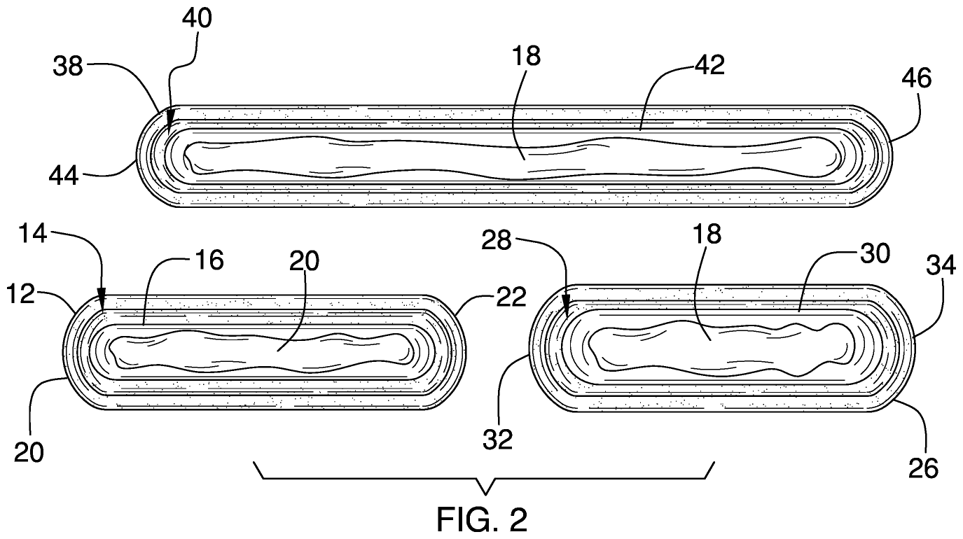

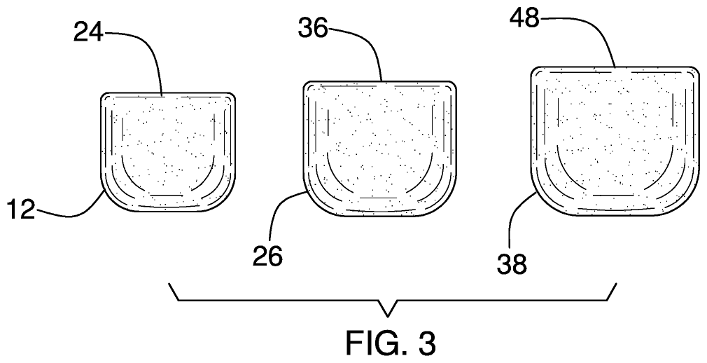

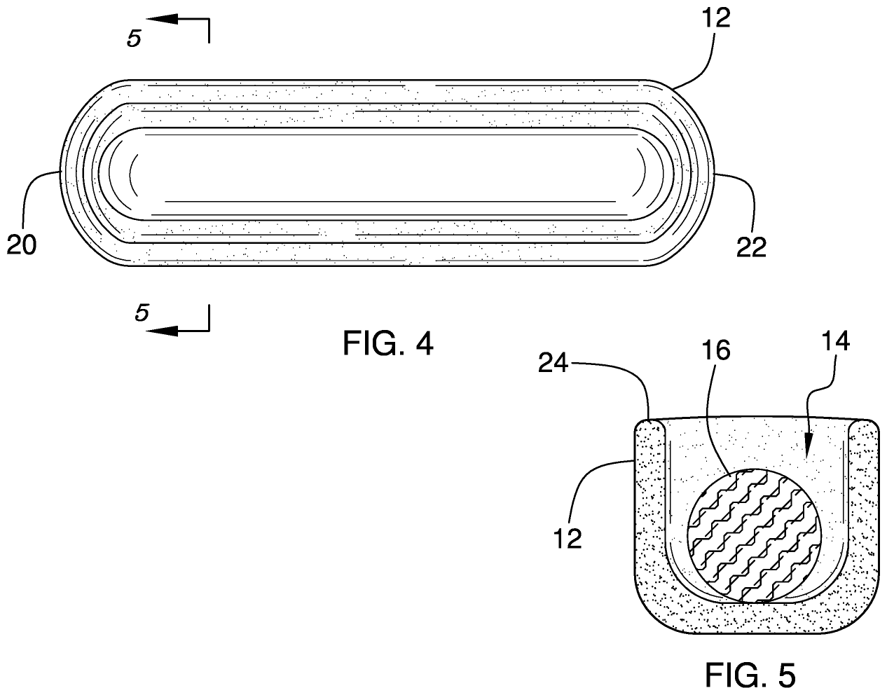

With reference now to the drawings, and in particular to FIGS. 1 through 5 thereof, a new bun device embodying the principles and concepts of an embodiment of the disclosure and generally designated by the reference numeral 10 will be described.

As best illustrated in FIGS. 1 through 5, the sausage bun assembly 10 generally comprises a hot dog bun 12 has a hot dog depression 14 therein for containing a hotdog 16 within the hot dog bun 12. The hot dog depression 14 is closed at each end. In this way fluid condiments 18, such as ketchup, mustard or other condiments commonly put on hotdogs, are inhibited from spilling from the hot dog bun 12. The hot dog bun 12 has a first end 20, a second end 22 and a top side 24. The hot dog depression 14 extends downwardly into the top side 24 and the hot dog depression 14 extends substantially between each of the first end 20 and the second end 22. The hot dog bun 12 has a height of approximately 1.75 inches, a length of approximately 6.75 inches and a width ranging between approximately 1.75 inches and 2.0 inches.

A bratwurst bun 26 is included that has a bratwurst depression 28 therein for containing a bratwurst 30 within the bratwurst bun 26. The bratwurst depression 28 is closed at each end to inhibit fluid condiments 18, similar to the condiments that may be applied to the hot dog 16, from spilling from the bratwurst bun 26. The bratwurst bun 26 has a first end 32, a second end 34 and a top side 36, and the bratwurst depression 28 extends downwardly into the top side 36 of the bratwurst bun 26. Moreover, the bratwurst depression 28 extends substantially between each of the first end 32 of the bratwurst bun 26 and the second end 34 of the bratwurst bun 26. The bratwurst bun 26 has a height of approximately 2.0 inches, a length of approximately 6.0 inches and a width ranging between approximately 7.75 inches and 2.25 inches.

A foot long sausage bun 38 is included and the foot long sausage bun 38 has a foot long sausage depression 40 therein for containing a foot long sausage 42 within the foot long sausage bun 38. The foot long sausage depression 40 is closed at each end to inhibit fluid condiments 18 from spilling from the foot long sausage bun 38. The foot long sausage bun 38 has a primary end 44, a secondary end 46 and an upper side 48. The foot long sausage depression 40 extends downwardly into the upper side 48. Additionally, the foot long sausage depression 40 extends substantially between each of the primary end 44 and the secondary end 46. The foot long sausage bun 38 has a height of approximately 1.5 inches, a length of approximately 12.5 inches and a width ranging between approximately 1.25 inches and 1.75 inches. Each of the hot dog bun 12, the bratwurst bun 26 and the foot long sausage bun 38 are comprised of a food material, including but not being limited to, white bread, wheat bread, sourdough bread or any other type of leavened bread.

In use, a hot dog 16 and any desired fluid condiments 18 are placed into the hot dog depression 14 in the hot dog bun 12. In this way the hot dog 16 and the desired fluid condiments 18 can be eaten without the hot dog 16 or the fluid condiments 18 from sliding out of the hot dog bun 12. The same process is undertaken with the bratwurst bun 26 for eating a bratwurst 30 and any desired fluid condiments 18 on the bratwurst 30. Additionally, a foot long sausage 42 and any desired fluid condiments 18 can be placed into the foot long sausage depression 40 in the foot long sausage bun 38. In this way a hot dog 16, a bratwurst 30 or a foot long sausage 42 can be eaten without spilling anything onto a person that is eating.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sausage bun assembly being configured to contain a sausage and fluid condiments without spilling the fluid condiments, said assembly comprising:
a hot dog bun having a hot dog depression therein for containing a hotdog within said hot dog bun, said hot dog depression being closed at each end wherein said hot dog bun is configured to inhibit fluid condiments from spilling from said hot dog bun;
a bratwurst bun having a bratwurst depression therein for containing a bratwurst within said bratwurst bun, said bratwurst depression being closed at each end wherein said bratwurst bun is configured to inhibit fluid condiments from spilling from said bratwurst bun; and
a foot long sausage bun having a foot long sausage depression therein for containing a foot long sausage within said foot long sausage bun, said foot long sausage depression being closed at each end wherein said foot long sausage bun is configured to inhibit fluid condiments from spilling from said foot long sausage bun.

2. The assembly according to claim 1, wherein said hot dog bun has a first end, a second end and a top side, said hot dog depression extending downwardly into said top side, said hot dog depression extending substantially between each of said first end and said second end.

3. The assembly according to claim 2, wherein said bratwurst bun has a first end, a second end and a top side, said bratwurst depression extending downwardly into said top side of said bratwurst bun, said bratwurst depression extending substantially between each of said first end of said bratwurst bun and said second end of said bratwurst bun.

4. The assembly according to claim 3, wherein said bratwurst bun has a length being less than a length of said hot dog bun.

5. The assembly according to claim 1, wherein said foot long sausage bun has a primary end, a secondary end and a upper side, said foot long sausage depression extending downwardly into said upper side, said foot long sausage depression extending substantially between each of said primary end and said secondary end.

6. The assembly according to claim 5, wherein said foot long sausage bun has a length being greater than the length of said hot dog bun.

7. A sausage bun assembly being configured to contain a sausage and fluid condiments without spilling the fluid condiments, said assembly comprising:
a hot dog bun having a hot dog depression therein for containing a hotdog within said hot dog bun, said hot dog depression being closed at each end wherein said hot dog bun is configured to inhibit fluid condiments from spilling from said hot dog bun, said hot dog bun having a first end, a second end and a top side, said hot dog depression extending downwardly into said top side, said hot dog depression extending substantially between each of said first end and said second end;
a bratwurst bun having a bratwurst depression therein for containing a bratwurst within said bratwurst bun, said bratwurst depression being closed at each end wherein said bratwurst bun is configured to inhibit fluid condiments from spilling from said bratwurst bun, said bratwurst bun having a first end, a second end and a top side, said bratwurst depression extending downwardly into said top side of said bratwurst bun, said bratwurst depression extending substantially between each of said first end of said bratwurst bun and said second end of said bratwurst bun, said bratwurst bun having a length being less than a length of said hot dog bun; and
a foot long sausage bun having a foot long sausage depression therein for containing a foot long sausage within said foot long sausage bun, said foot long sausage depression being closed at each end wherein said foot long sausage bun is configured to inhibit fluid condiments from spilling from said foot long sausage bun, said foot long sausage bun having a primary end, a secondary end and a upper side, said foot long sausage depression extending downwardly into said upper side, said foot long sausage depression extending substantially between each of said primary end and said secondary end, said foot long sausage bun having a length being greater than the length of said hot dog bun.
